(19) United States
(12) Patent Application Publication
(10) Pub. No.: US 2012/0127043 A1
(43) Pub. Date: May 24, 2012

(54) PORTABLE RADIO

(75) Inventors: Daigo Imano, Miyagi (JP); Kenya Nagano, Ishikawa (JP); Yoshio Koyanagi, Kanagawa (JP); Noriyoshi Sato, Kanagawa (JP)

(73) Assignee: PANASONIC CORPORATION, Osaka (JP)

(21) Appl. No.: 13/387,948

(22) PCT Filed: Mar. 4, 2010
(86) PCT No.: PCT/JP2010/001530

§ 371 Date: Jan. 30, 2012

(30) Foreign Application Priority Data
Aug. 5, 2009 (JP) 2009-182528

(51) Int. Cl. H01Q 1/24

(52) U.S. Cl. 343/702

(57) ABSTRACT

A portable radio having a housing 10 made up of a combination of a first case 11 and a second case 12 includes: an annular resilient member 13 sandwiched between the first case 11 and the second case 12; a flexible printed board 14 that is formed integrally with the annular resilient member 13 and that is provided in at least an area surrounded by the annular resilient member 13; an antenna section 15 that is provided on the flexible printed board 14 while being folded along a plurality of inner wall surfaces which are oriented in mutually different orientations and which belong to at least one of the first case 11 and the second case 12; and a circuit board 17 placed within an area surrounded by the annular resilient member 13.

### TECHNICAL FIELD

The present invention relates to a portable radio usable for; for instance, a cell phone terminal, a personal digital assistant (PDA), a portable music player, a portable game machine, and the like, and, more particularly, to a structure for implementing an antenna housed in a housing and fulfilling a waterproof function.

### BACKGROUND ART

Performance of an antenna for radio communication is greatly dependent on a distance between an antenna element and a ground. Specifically, as the distance between the antenna element and the ground becomes smaller, radiation resistance becomes weaker, whereby an antenna gain decreases.

In portable radios like, for instance, cell phone terminals, an antenna built in a housing has recently gone mainstream from the viewpoint of a design characteristic. Further, a portable radio needs to contain a large number of electric components, or the like, to implement various functions, within a small, slim housing. In fact, a printed board mounted with an electronic circuit comes to occupy the majority of internal space of the housing. For the purpose of electrostatic shielding, it is common to form a ground pattern in the majority of a printed board. Accordingly, when an antenna element is accommodated in the housing, it is common to place an antenna element in the vicinity of an end in the housing, to thus make a distance between the antenna element and the ground pattern on the printed board larger, in order to prevent occurrence of a drop in antenna gain.

Incidentally, a recent portable radio has been required to exhibit functions, like watertightness and dust resistance. Accordingly, in order to prevent intrusion of moisture into an interior of the housing, like a printed board, from the outside, members, such as a waterproof gasket and a dustproof gasket, are placed at an end of the housing so as to surround an electric circuit, like a printed board.

However, when the waterproof gasket and the dustproof gasket are placed at the end of the interior of the housing, the gaskets make a space left in the housing smaller. As a result, the antenna element cannot be set at the end of the housing and comes to be placed at an inner position with reference to the gaskets. Therefore, the distance between the antenna element and the printed board becomes smaller, so that the antenna characteristic becomes deteriorated.

The related art pertaining to a portable radio having a waterproof structure is disclosed in; for instance, Patent Document 1. Patent Document 1 provides a disclosure about a housing that is made up of an upper case and a lower case; a frame-shaped waterproof gasket that exists in a joint between the upper case and the lower case; and an antenna element that is embedded in the waterproof gasket.

### RELATED ART DOCUMENT

### Patent Document

Patent Document 1: JP-A-6-37876

### DISCLOSURE OF THE INVENTION

### Problem that the Invention is to Solve

However, the related art technique described in connection with Patent document 1 makes it possible to form only a linear element as an antenna element to be adopted. Therefore, resultant antenna performance exhibits only single resonance and a narrow band. Moreover, difficulty is encountered in adjusting the length of an antenna element. Adding a circuit component to achieve a wider broadband is also difficult.

In the meantime, when the technique described in connection with Patent Document 1 is not adopted, difficulty is encountered in placing an antenna element along a periphery of a housing because of a positional relationship between a member, like a gasket, and the antenna element. Accordingly, the size of the housing must be increased in order to place the antenna element at a position distant from the ground pattern on the circuit board; namely, to prevent occurrence of a drop in antenna gain. In particular, in order to make up an antenna exhibiting a broadband characteristic, the antenna element having a large width must be used. It is difficult to place the antenna element within a small housing while sufficiently spaced apart from the circuit board.

The present invention has been conceived in light of the circumstance and aims at providing a portable radio capable of housing within a small housing of an antenna that exhibits waterproof function; that prevents occurrence of a drop in antenna gain; and that exhibits a broadband characteristic.

### Means for Solving the Problem

A portable radio of the present invention is a portable radio having a housing in which a first case and a second case are combined, comprising: an annular resilient member sandwiched between the first case and the second case; a flexible printed board that is formed integrally with the annular resilient member and that is provided in at least an area surrounded by the annular resilient member; an antenna section that is provided on the flexible printed board while being folded along a plurality of inner wall surfaces which are oriented in mutually different directions, the plurality of inner wall surface belonging to at least one of the first case and the second case; and a circuit board placed within an area surrounded by the annular resilient member.

In the portable radio, since the antenna section is folded so as to run along the inner wall surfaces oriented in mutually different directions, the wide antenna section can be accommodated within narrow space in the housing. For instance, the antenna section is configured so as to be partially folded so as to run along the bottom of the housing and a thicknesswise direction of the same, whereby the antenna section can be accommodated within narrow space. Therefore, even when the housing is small, the circuit board and the antenna section in the housing can be spaced apart from each other, thereby making it possible to prevent occurrence of a drop in antenna gain. Further, using a wide conductor pattern makes it possible to impart a wider bandwidth to a characteristic of the antenna.

In the portable radio of the present invention, at least either the first case or the second case has an antenna holding section that nips the antenna section between the antenna holding section and the inner wall surfaces so as to run along the inner wall surfaces.

In the portable radio, even when force develops in the antenna section on the flexible printed board so as to go back the antenna section to its original, unfolded shape, the shape of the antenna section on the flexible printed board can be held so as to run along the inner wall surfaces. Accordingly, since the shape of the antenna section can be made stable, occurrence of variations in shape, which would arise during production, is prevented, so that the antenna characteristic can be made stable.

Further, in the portable radio of the present invention, at least either the first case or the second case has an antenna holding section that has a trench for nipping the antenna section between the antenna holding section and the inner wall surfaces so as to run along the inner wall surfaces.

In the portable radio, even when force develops in the antenna section on the flexible printed board so as to go back the antenna section to its original, unfolded shape, the shape of the antenna section on the flexible printed board can be held so as to run along the inner wall surfaces. Accordingly, the shape of the antenna section can be made stable, occurrence of variations in shape, which would arise during production, is prevented, so that the antenna characteristic can be made stable.

The portable radio of the present invention also includes a first feed section that is provided on the flexible printed board along the inner wall surface opposing the circuit board and that is electrically connected to the antenna section; an electric circuit section placed on the circuit board; and a second feed section electrically connected to the electric circuit section, wherein the first feed section and the second feed section are disposed so as to face each other.

Even when the portable radio is provided with a plurality of radio communication systems or when a plurality of antenna sections are mounted on the flexible printed board in order to implement a radio communication system that performs diversity communication, the portable radio can get a space isolation among the respective antennas by means of arranging the antenna sections so as to oppose each other. Further, the portable radio can decrease gains of the respective antennas and provide a wider bandwidth to the respective antennas.

### Advantage of the Invention

The present invention makes it possible to house within a small housing an antenna that exhibits waterproof function; that prevents occurrence of a drop in antenna gain; and that exhibits a broadband characteristic.

### BRIEF DESCRIPTION OF THE DRAWINGS

FIG. 1 is an oblique perspective view showing a layout of principal constituent elements within a portable radio of an embodiment of the present invention.

FIG. 2 is a cross sectional view of the portable radio shown in FIG. 1 taken along line A-A′.

FIG. 3 is an exploded perspective view showing the principal constituent elements of the portable radio shown in FIG. 1.

FIG. 4 is a partially enlarged cross sectional view achieved when viewed in a direction of line B-B′ shown in FIG. 3.

FIG. 5 is a plan view showing an example entire shape of a flexible printed board provided in the portable radio shown in FIG. 1.

FIG. 6 is a partially enlarged perspective view showing an example neighborhood of an antenna in the portable radio shown in FIG. 1.

FIG. 7 is a partially enlarged cross sectional view showing an example configuration of a neighborhood of the flexible printed board in a portable radio of a first modification of the embodiment of the present invention.

FIG. 8 is partially enlarged cross sectional view showing an example configuration of a neighborhood of the flexible printed board of a portable radio of a second modification of the embodiment of the present invention.

FIG. 9 is an oblique perspective view showing a layout of principal constituent elements within a portable radio of a third modification of the embodiment of the present invention.

FIG. 10 is a partially enlarged perspective view showing an example neighborhood of an antenna in the portable radio shown in FIG. 9.

FIG. 11 is an oblique perspective view showing a layout of principal constituent elements within a portable radio of a fourth modification of the embodiment of the present invention.

FIG. 12 is a partially enlarged perspective view showing an example neighborhood of an antenna in the portable radio shown in FIG. 11.

FIG. 13 is an oblique perspective view showing a layout of principal constituent elements within a portable radio of a fifth modification of the embodiment of the present invention.

FIG. 14 is a partially enlarged perspective view showing an example neighborhood of an antenna in the portable radio shown in FIG. 13.

FIG. 15 is an oblique perspective view showing a layout of principal constituent elements within a portable radio of a sixth modification of the embodiment of the present invention.

FIG. 16 is a partially enlarged perspective view showing an example neighborhood of an antenna in the portable radio shown in FIG. 15.

FIG. 17 is an oblique perspective view showing a layout of principal constituent elements within a portable radio of a seventh modification of the embodiment of the present invention.

### EMBODIMENT FOR CARRYING OUT THE INVENTION

Portable radio of an embodiment of the present invention is hereinafter described by reference to the drawings.

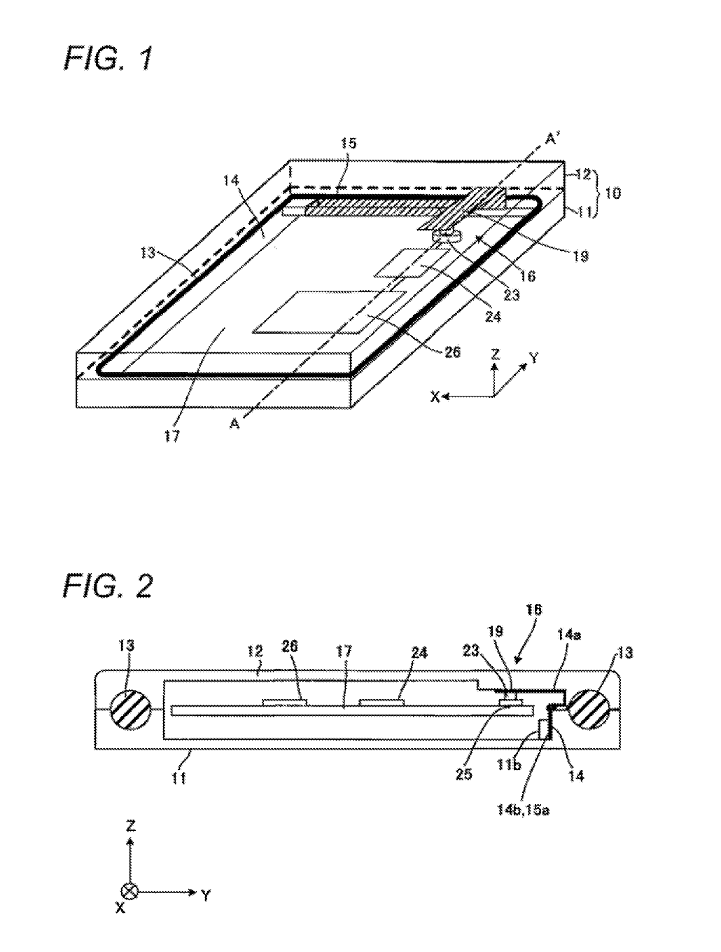

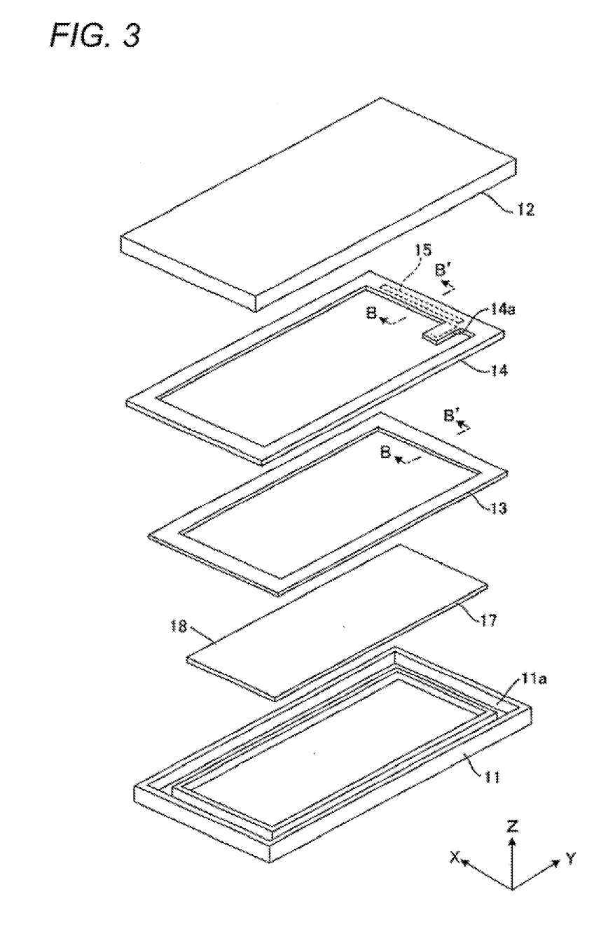

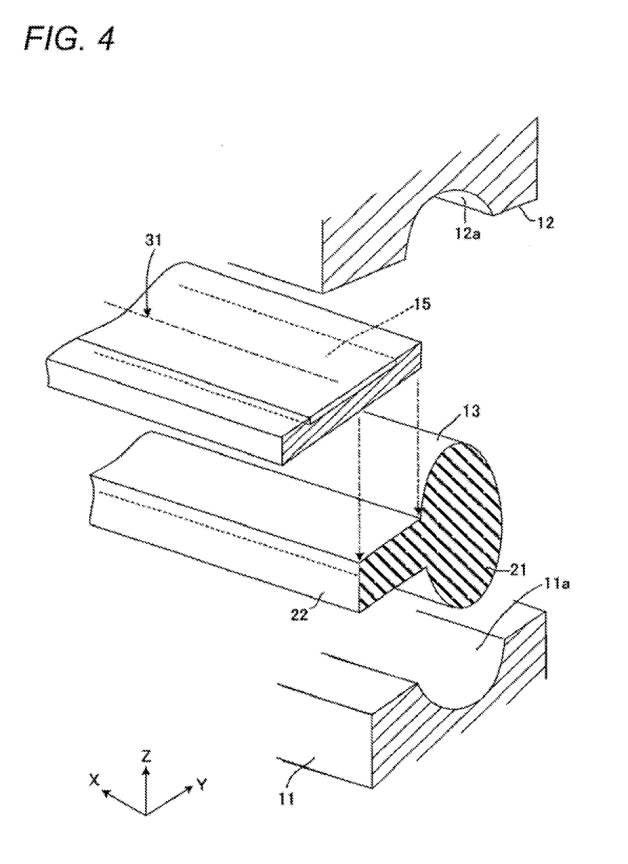

FIG. 1 is a view showing a brief layout of principal constituent elements within a portable radio of an embodiment of the present invention. FIG. 1 shows only an outline of an outer circumference of a housing so that the constituent elements in the housing can be viewed through the housing. FIG. 2 is a view showing an example achieved when a cross section taken along line A-A′ shown in FIG. 1 is viewed from X-axis direction. FIG. 3 is a perspective view of an example exploded state of the portable radio shown in FIG. 1. FIG. 4 is an exploded perspective view showing an example achieved when a cross section taken along line B-B′ shown in FIG. 3 is viewed from Y-axis direction.

The portable radio shown in FIG. 1 is; for instance, a cell phone terminal, and has a wireless communication function and an antenna. The housing 10 of the portable radio assumes a fixed shape that remains unchanged. The housing 10 is built by combining the first case 11 with the second case 12, which are shown in FIG. 3, in a thickness direction (Z-axis direction) and by fitting the first and second cases 11 and 12 to each other. The circuit board 17 mounted with the electric circuit section 18, the flexible printed board 14, and the annular resilient member 13 are accommodated in inner space of the housing 10 as shown in FIG. 3.

In fact, the annular resilient member 13 and the flexible printed board 14 are configured as a single component made by integral molding. For instance, the previously-formed flexible printed board 14 is fitted to a predetermined mold, and a material for the annular resilient member 13 is poured, while remaining in a fluidized state, into internal space of the mold, and the thus-poured material is solidified. The flexible printed board 14 and the annular resilient member 13 can be thereby integrated into one.

The antenna section 15 formed as; for instance, a metal print pattern (of a conductor) (usually formed by machining printed copper foil into a predetermined shape by means of etching, or the like) is mounted on the flexible printed board 14.

As shown in FIGS. 1 and 3, a planar shape of the housing 10 and the circuit board 17 is; for instance, a rectangular shape. The circuit board 17 is accommodated into a space located inside the annular resilient member 13 within X-Y plane.

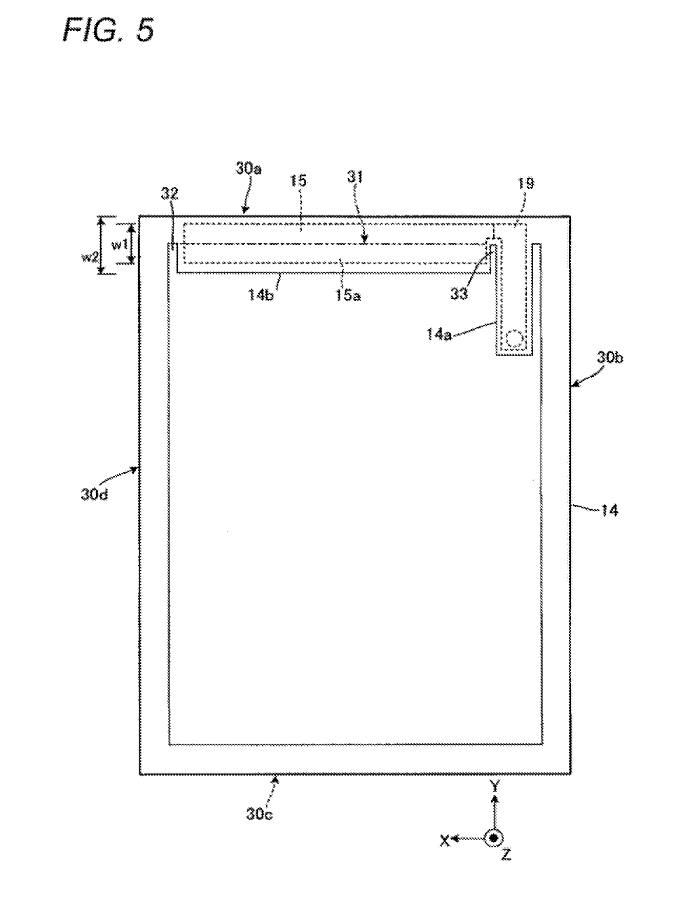

FIG. 5 is a view showing an example entire shape of the flexible printed board 14. In the example shown in FIG. 5, the flexible printed board 14 is formed into a substantially annular shape (the shape of a frame) that enables surrounding of an entire circumference of the circuit board 17. Specifically, the flexible printed board 14 has four sides 30a, 30b, 30c, and 30d. Each of an outer circumference and an inner circumference is formed so as to assume a substantially-rectangular contour. The contour of the inner circumference of the flexible printed board 14 is made slightly larger than an outer circumference of the circuit board 17. In addition, the contour of the outer circumference of the flexible printed board 14 is made slightly larger than the contour of the inner circumference of the same. Further, the contour of the outer circumference of the flexible printed board 14 enables an internal space of the housing 10 to accommodate the flexible printed board 14.

Therefore, as shown in FIG. 1, the flexible printed board 14 is placed within the annular resilient member 13 and in parallel with a position close to the outer circumference of the housing 10. The circuit board 17 can be set within the inner circumference of the flexible printed board 14. The shape of the flexible printed board 14 does not always need to be made in an annular shape so as to surround the circuit board 17. The flexible printed board 14 can also be placed in only a neighborhood of a location where the antenna section 15 is disposed. A portion of the flexible printed board can also be configured so as to extend outside from the annular resilient member.

As shown in FIG. 5, the portable radio of the present embodiment has the rectangular antenna section 15 elongated along X-axis direction and a first feed section 19 electrically connected to the antenna section 15, wherein both the antenna section 15 and the first feed section 19 are provided on the flexible printed board 14. The first feed section 19 is formed from; for instance, a print pattern, as is the antenna section 15. A portion of the first feed section 19 close to the antenna section 15 may also act as the antenna section 15. The antenna section 15 is placed along the one side 30a on the flexible printed board 14. A width w1 of the antenna section 15 is made smaller than a width w2 of the side 30a of the flexible printed board 14.

Notches 32 and 33 are formed in both ends of a turn-up 14b of the flexible printed board 14 in such a way that the turn-up 14b of the flexible printed board 14 becomes foldable along a predetermined reference axis 31. Although the position of the reference axis 31 is set at; for instance, a point around a center of the side 30a along a widthwise direction (Y-axis direction). However, the position of the reference axis 31 is not limited to this point. The position of the reference axis 31 can be flexibly set according to a width of the side 30a and a width of the antenna section 15. When the turn-up 14b of the flexible printed board 14 (i.e., an area located between the notches 32 and 33) is folded along the reference axis 31, a turn-up 15a that is a portion of the antenna section 15 is also folded in conjunction with the turn-up 14b.

In order to facilitate making of an electrical connection to feed electric power to the antenna section 15, for instance, a rectangular extension 14a elongated (provided in an extended manner) toward the inner circumference side, or the circuit board 17, is formed in a vicinity of one end of the side 30a of the flexible printed board 14. The first conductive feed section 19 electrically connected to the antenna section 15 is elongated up to a neighborhood of an extremity of the extension 14a.

The annular resilient member 13 is a resilient member primarily intended for providing waterproof function and embodied as; for instance, a rubber gasket. A planer shape of the annular resilient member 13 is annular like the flexible printed board 14. Both an inner circumference and an outer circumference of the annular resilient member 13 are formed so as to assume; for instance, a rectangular plane shape. The outer circumference of the annular resilient member 13 is made larger than the outer circumference of the flexible printed board 14 and made so that the annular resilient member 13 can be accommodated in an internal space of the housing 10.

Moreover, as shown in FIG. 4, the annular waterproof section 21 and the extension 22 are made integrally as the annular resilient member 13. The annular waterproof section 21 assumes a curved shape whose center bulges up and down along Z-axis direction and a substantially elliptical cross sectional profile. The extension 22 extends (provided in an extended manner) from a portion of the annular waterproof section 21 toward an inner circumference side; i.e., toward the circuit board 17, and is formed into the shape of a flat plate. The thickness of the annular waterproof section 21 is sufficiently larger than the thickness of the extension 22.

As shown in FIG. 4, the flexible printed board 14 is fixed (integrated) while a part thereof (e.g., about one-half of the flexible printed board 14 in its widthwise direction) remains laid over the extension 22 in the thickness direction. An outer-circumference-side end of the flexible printed board 14 is provided along the annular waterproof section 21. Alternatively, the flexible printed board 14 and the annular resilient member 13 may also be integrated together in such a positional relationship that the outer-circumference-side end of the flexible printed board 14 and its neighborhood are embedded in the annular waterproof section 21.

In order to impart waterproof function: namely, to eliminate clearance between the annular waterproof section 21 and an internal wall surface of the housing 10 that holds the annular waterproof section 21 in a sandwiched manner and to exert appropriate suppression force, a curved indentation matching the shape of the annular waterproof section 21 is formed in each of a resilient member holding section 11a provided on the first case 11 and a resilient member holding section 12a provided on the second case 12. The resilient member holding sections 11a and 12a are annually formed in conformance to the shape and size of the annular resilient member 13.

In order to hold the turn-up 14b of the flexible printed board 14 in a folded state, a folded state holding section 11b is formed in an inner wall surface of the bottom of the first case 11 as shown in FIG. 2. The folded state holding section 11b is a projection that projects from a bottom surface of the first case 11 in an upward direction (Z-axis direction) and extends in the shape of a rib along X-axis direction. A narrow indentation is formed between the folded state holding section 11b and the inner wall surface of the first case 11 opposing the folded state holding section 11b. The turn-up 14b of the flexible printed board 14 is inserted into the indentation. Since the turn-up 14b is nipped between the folded state holding section 11b and the inner wall surface opposing the folded state holding section 11b and held in a folded state.

Therefore, the flexible printed board 14 is accommodated into the housing 10 while assuming an area that is provided along the inner bottom wall (Y-axis direction) and the turn-up 14b that is an area provided along an inner side wall surface (Z-axis direction). Even in relation to the antenna section 15 provided on the flexible printed board 14, the turn-up 15a shown in FIG. 5 is folded along with the turn-up 14b and provided along Z-axis direction. The folded state of the flexible printed board 14 does not always need to be kept by use of the narrow indentation existing between the folded state holding section 11b and the inner wall surface of the first case 11 opposing the folded state holding section 11b. The flexible printed board and the inner wall surface of the first case 11 may also be held by use of a double-sided tape, an adhesive, or the like.

Therefore, in the state shown in FIG. 2, the width of the antenna section 15 achieved in Y-axis direction on the flexible printed board 14 is sufficiently smaller than the width w1 shown in FIG. 5. Accordingly, even when the width w1 of the antenna section 15 is large, a distance between the turn-up 15a and the circuit board 17 can be made sufficiently large in Y-axis direction. A characteristic of the antenna can be given a broader bandwidth by adoption of the antenna section 15 whose width w1 is large. Deterioration of radiation resistance of the antenna and deterioration of an antenna gain can be prevented by increasing a distance between the antenna section 15 and a ground section (not shown) on the circuit board 17. The ground section is formed from; for instance, a print pattern.

As shown in FIG. 1, the radio section 26 is mounted on the circuit board 17. The radio section 26 is an electrical circuit for sending and receiving a radio signal (a radio wave) by way of the antenna section 15. The radio section 26 is electrically connected to the antenna section 15 on the flexible printed board 14 by way of the matching circuit 24 and a feed section 16. The matching circuit 24 is a circuit that matches impedance of the radio section 26 to impedance of the antenna section 15.

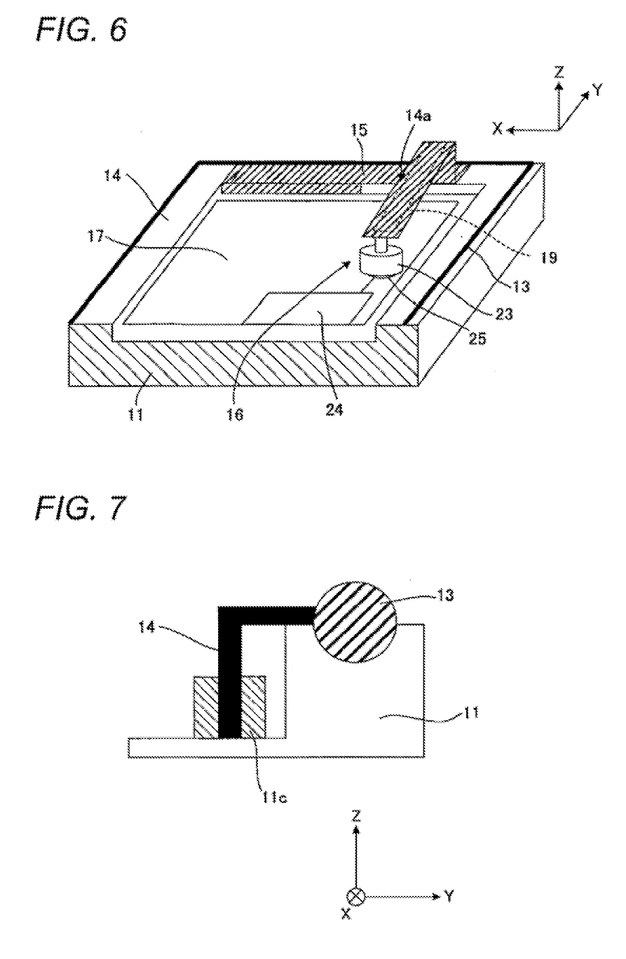

FIG. 6 is a view showing an example enlarged state of a neighborhood of the feed section 16 of the portable radio shown in FIG. 1. The feed pin 23 is provided, as an example second feed section made up of a conductor, at a predetermined position on the circuit board 17 in a projection fashion. The feed pin 23 is electrically connected to the matching circuit 24 by way of the feed land 25 that is an electrode put on the circuit board 17. The extension 14a extending from a periphery of the flexible printed board 14 toward the inner circumference is provided along an inner circumferential wall of the second case 12, and the extremity of the extension 14a extends up to a position where the extension 14a opposes the feed pin 23 in the thickness direction (i.e., Z-axis direction).

As shown in FIG. 2, the electrode of the first feed section 19 on the extension 14a and the feed pin 23 oppose each other, to thus be electrically connected together. The first case 11 and the second case 12 exert suppression in their thickness direction in such a way that the feed section 16 sustains the electrically connected state. The extension 14a is folded upwardly (in Z-axis direction), and the shape of the extension 14a is adjusted so as to extend in a direction parallel to Y-axis direction along the inner peripheral wall of the second case 12.

The ground section is formed on the circuit board 17. The antenna section 15 is formed so as to be spaced as far as possible from the ground section 17, thereby making it possible to increase radiation resistance of the antenna and prevent occurrence of a gain drop. The antenna characteristic can be given a wider bandwidth by adoption of the antenna section 15 having a wide width w1. As a result of the antenna section 15 being arranged with its portion folded, a sufficient distance between the antenna section 15 and the circuit board 17 is assured, so that a broadband antenna characteristic can be yielded.

In relation to the distance between the ground section of the circuit board 17 and the antenna section 15, they are assumed to be arranged while separated a few millimeters away from each other. Although the distance is sometimes restricted depending on the size of the housing 10 or empty space, it is necessary to set the distance in such a way that an average distance comes to 0.01 λ or more with respect to a wavelength λ of a radio frequency employed; preferably, to a distance of about 0.1 λ to 0.2 λ.

Since the turn-up 15a of the antenna section 15 is held in a folded state in conjunction with the flexible printed board 14, the portable radio of the present embodiment is provided with the rib-shaped projection as the folded state holding section 11b on the first case 11. Various example modifications are conceivable to maintain the folded state.

For instance, in a first modification shown in FIG. 7, a folded state holding section 11c having, as an indentation, a gap having substantially the same thickness as that of the turn-up 14b of the flexible printed board 14 is formed, in place of the foregoing folded state holding section 11b, on the bottom of the first case 11. Accordingly, the turn-up 14b of the flexible printed board 14 can be nipped while being inserted into the indentation of the folded state holding section 11c, and the turn-up can be kept folded. Therefore, the turn-up 15a of the antenna section 15 is also held by the folded state holding section 11c.

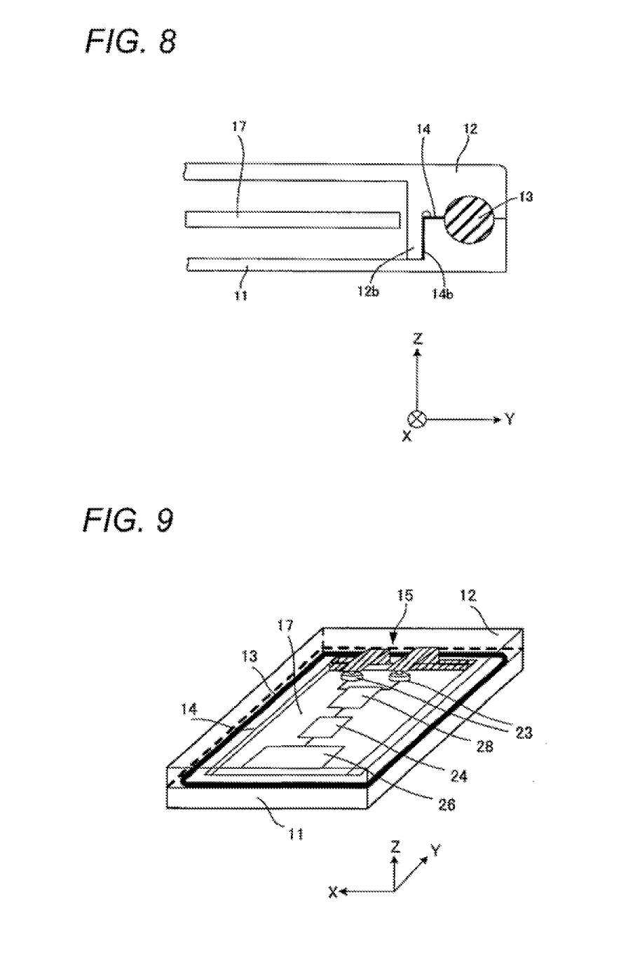

In a second modification shown in FIG. 8, a projection protruding toward the first case 11 is formed as a folded state holding section 12b on the second case 12. Specifically, when the first case 11 and the second case 12 are assembled together, a gap having substantially the same thickness as that of the flexible printed board 14 is formed between the projection of the folded state holding section 12b and the inner wall surface of the first case 11. The turn-up 14b of the flexible printed board 14 is nipped in a folded state along the gap, so that the turn-up 14b can sustain its folded shape. Accordingly, the turn-up 15a of the antenna section 15 is also held by the folded state holding section 12b.

The portable radio shown in FIGS. 1 through 6 has been described on the assumption that a monopole antenna having the simplest configuration is accommodated in the housing 10. Various types of other antennas can also be accommodated in the portable radio in much the same way as the configuration shown in FIGS. 1 through 6.

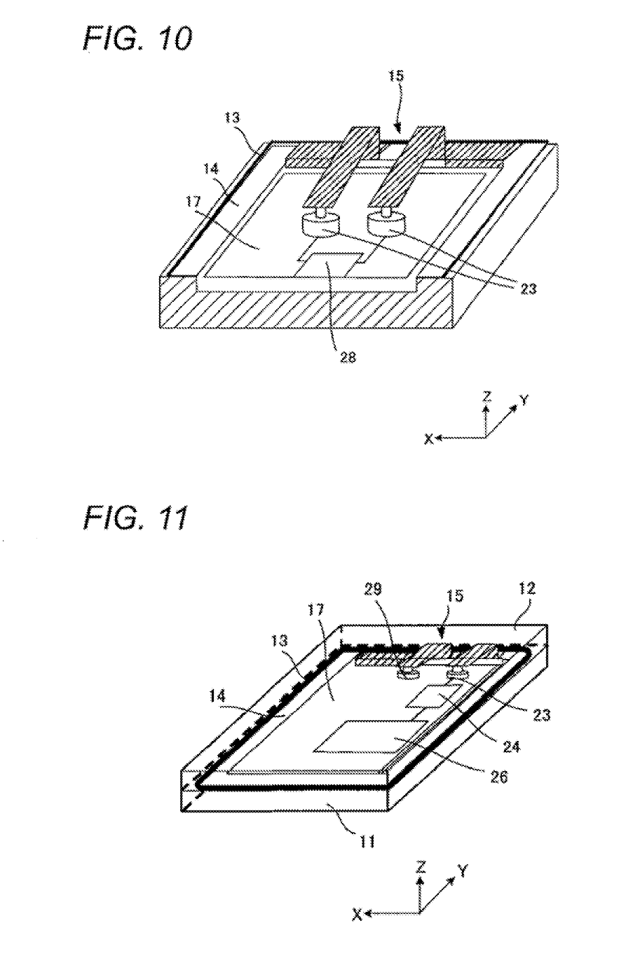

For instance, a third modification shown in FIGS. 9 and 10 is based on the assumption that a dipole antenna is accommodated in the housing 10 of the portable radio. Specifically, two antenna elements are formed on the flexible printed board 14, and the antenna section 15 acting as one dipole antenna is formed. The portable radio is provided with the balun 28 interposed between the feed pin 23 and the matching circuit 24 for the purpose of balanced-unbalanced conversion.

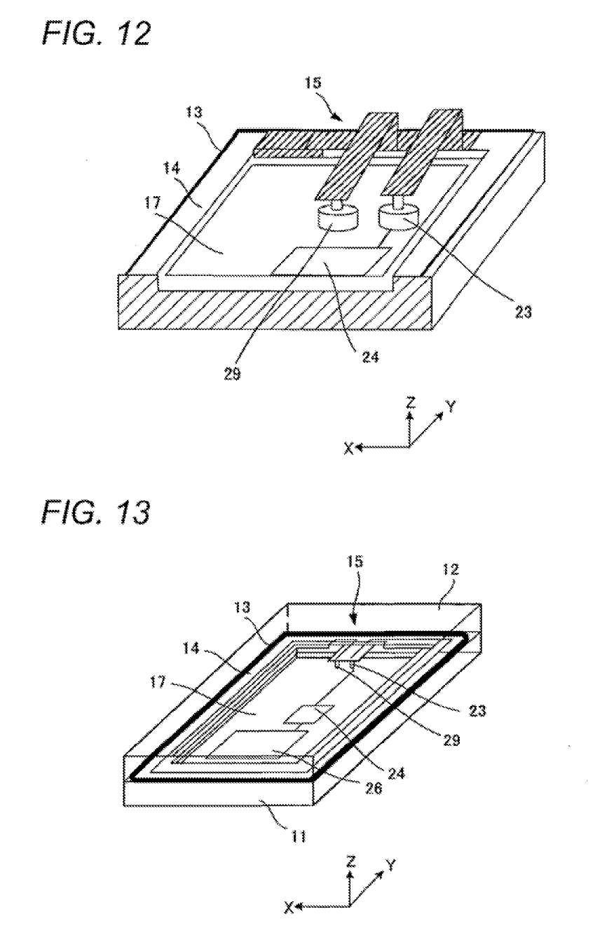

Likewise, a fourth modification shown in FIGS. 11 and 12 is based on the assumption that an inverted F antenna is accommodated in the housing 10 of the portable radio. The antenna section 15 acting as the inverted F antenna is formed on the flexible printed board 14. Reference numeral 29 denotes a ground pin connected to the ground section of the circuit board 17.

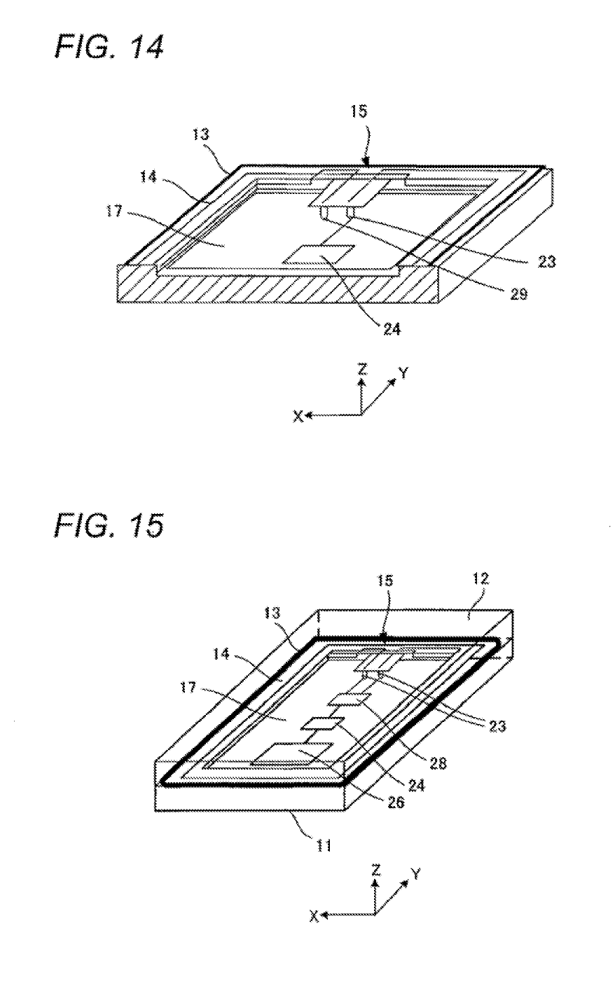

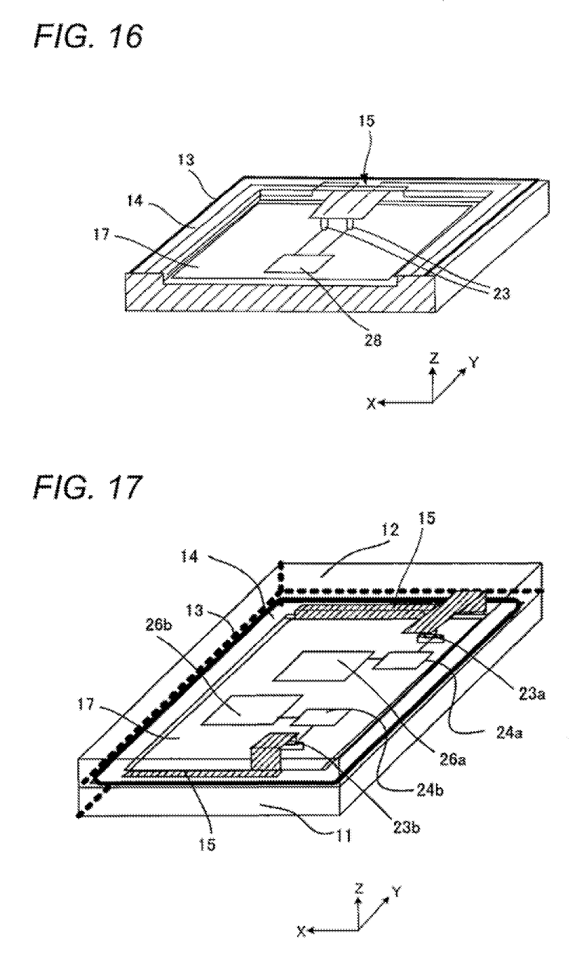

A fifth modification shown in FIGS. 13 and 14 is based on the assumption that the antenna section 15 acting as an unbalanced loop antenna is accommodated in the housing 10 of the portable radio. A sixth modification shown in FIGS. 15 and 16 is based on the assumption that the antenna section 15 acting as a balanced loop antenna is accommodated in the housing 10 of the portable radio. Even in either of the modifications, the antenna section 15 of the loop antenna is formed on the flexible printed board 14.

The plurality of independent antennas can be accommodated in the housing 10 of the portable radio. In a seventh modification shown in FIG. 17, two antenna sections 15 acting as mutually-independent antennas are placed at different positions (at respective ends of the flexible printed board in Y-axis direction) on the flexible printed board 14. The antenna section 15 acting as a first antenna is connected to the first radio section 26a by way of the first pin 23a and the first matching circuit 24a, and the antenna section 15 acting as a second antenna is connected to the second radio section 26b by way of the second feed pin 23b and the second matching circuit 24b.

The present embodiment is based on the assumption that the housing 10 whose shape remains unchanged is used, a portable radio, such as a cell phone terminal, often uses for the housing 10 a housing whose shape can be changed by opening or sliding action. The forms is configured by means of joining together an upper housing and a lower housing, which are independent of each other and which are linked by way of a hinge, or the like. When such a deformable housing is used, there can also be conceived a configuration in which the circuit board 17 equipped with a radio circuit is accommodated in any one of the upper and lower housings and the flexible printed board 14 or the resilient annular member 13.

As mentioned above, the portable radio of the present embodiment is a portable radio having the housing 10 made up of the combination of the first case 11 and the second case 12. The portable radio includes the annular resilient member 13 sandwiched between the first case 11 and the second case 12; the flexible printed board 14 that is formed integrally with the annular resilient member 13 and that is provided in an area surrounded by the annular resilient member 13; the antenna section 15 that is provided on the flexible printed board 14 and that is provided along a plurality of inner wall surfaces that belong to at least the first case 11 or the second case 12 and that are mutually oriented in different orientations; and the circuit board 17 that is placed in an area surrounded by the annular resilient member 13.

The portable radio of the embodiment exhibit waterproof and dust-resistant functions; can prevent deterioration of an antenna gain; and can house the antenna section 15 having a broadband characteristic in the compact housing 10. Specifically, since the antenna section 15 has the turn-up 15a, the antenna section 15 having a large width w1 can be accommodated in narrow space. Therefore, even when the housing 10 is small, the ground section of the circuit board 17 and the antenna section 15 within the housing 10 can be spaced apart from each other, whereby a drop of antenna gain can be prevented. Further, a broader bandwidth can be imparted to the antenna characteristic by use of the antenna section 15 having the large width w1.

Although the present invention has been described in detail by reference to the specific embodiments, it is manifest to those skilled in the art that the present invention be susceptible to various alterations or modifications without departing the spirit and scope of the present invention.

The present patent application is based on Japanese Patent Application No. 2009-182528 filed on Aug. 5, 2009, the entire subject matter of which is incorporated herein by reference.

### INDUSTRIAL APPLICABILITY

The present invention is useful for a portable radio, or the like, that exhibits a waterproof function and that prevents a drop in antenna gain and that can accommodate in a compact housing an antenna exhibiting a broadband characteristic.

### DESCRIPTION OF THE REFERENCE NUMERALS AND SYMBOLS

10 HOUSING
11 FIRST CASE
11a RESILIENT MEMBER HOLDING SECTION 11b, 11c FOLDED STATE HOLDING SECTION
12 SECOND CASE
12a RESILIENT MEMBER HOLDING SECTION
12b FOLDED STATE HOLDING SECTION
13 ANNULAR RESILIENT MEMBER
14 FLEXIBLE PRINTED BOARD
14a EXTENSION
14b TURN-UP
15 ANTENNA SECTION
15a TURN-UP
16 FEED SECTION
17 CIRCUIT BOARD
18 ELECTRIC CIRCUIT SECTION
19 FIRST FEED SECTION
21 ANNULAR WATERPROOF SECTION
22 EXTENSION
23 FEED PIN (SECOND FEED SECTION)
24 MATCHING CIRCUIT
25 FEED LAND
26 RADIO SECTION
28 BALUN
29 GROUND PIN
31 REFERENCE AXIS
32, 33 NOTCH

1. A portable radio having a housing in which a first case and a second case are combined, comprising:
an annular resilient member sandwiched between the first case and the second case;
a flexible printed board that is formed integrally with the annular resilient member and that is provided in at least an area surrounded by the annular resilient member;
an antenna section that is provided on the flexible printed board while being folded along a plurality of inner wall surfaces which are oriented in mutually different direction, the plurality of inner wall surfaces belonging to at least one of the first case and the second case; and
a circuit board placed within an area surrounded by the annular resilient member.

2. The portable radio according to claim 1, wherein at least either the first case or the second case has an antenna holding section that nips the antenna section between the antenna holding section and the inner wall surfaces so as to run along the inner wall surfaces.

3. The portable radio according to claim 1, wherein at least either the first case or the second case has an antenna holding section that has a trench for nipping the antenna section between the antenna holding section and the inner wall surfaces so as to run along the inner wall surfaces.

4. The portable radio according t claim 1, further comprising:
a first feed section that is provided on the flexible printed board along the inner wall surface opposing the circuit board and that is electrically connected to the antenna section;
an electric circuit section placed on the circuit board; and
a second feed section electrically connected to the electric circuit section, wherein the first feed section and the second feed section are disposed so as to face each other.
